(19) United States
(12) Patent Application Publication
(10) Pub. No.: US 2008/0078817 A1
(43) Pub. Date: Apr. 3, 2008

(54) Photograph mailer with integral frame

(76) Inventors: Jennifer S. Harper, San Antonio, CA (US); Brook G. Rosser, San Antonio, CA (US)

Correspondence Address: David Allen Hall, P.O Box 1540, Blanco, TX, 78506, US

(21) Appl. No.: 11/904,995

(22) Filed: Sep. 28, 2007

Related U.S. Application Data
(60) Provisional application No. 60/849,166, filed on Oct. 2, 2006.

(51) Int. Cl. B42D 15/02

(52) U.S. Cl. 229/92.8

(57) ABSTRACT

A device for mailing and displaying one or many photographs and other flat objects. The mailer offers a convenient means of mailing more than twenty photographs or other flat objects in an attractive envelope that has a preprinted area for a mailing address and an easily removed perforated panel that allows the recipient to quickly view the mailer contents. A foldable panel serves as an easel for quick and easy display of the exposed photograph.

This patent claims priority from and incorporates by reference the provisional U.S. Patent Application Ser. No. 60/849,166 filed by the same co-inventors on Oct. 2, 2006.

### BACKGROUND OF THE INVENTION

The present invention relates to the fields of parcel mailers and photograph albums, namely devices that may be used for mailing, displaying, and viewing photographs. Current art does not contain all the features claimed by the present invention. The present invention offers a combination of utility, convenience, aesthetics, and affordability not available in current photograph mailers.

### BRIEF DESCRIPTION OF THE DRAWINGS

FIG. 1 is a plan view of the non-decorative side of the preferred embodiment of the present invention in its flat, cut-out, unfolded, initial configuration, including a single line of sample text (“See back for peel away frame!!”) printed on frame front panel 10.

FIG. 2 is a plan view of a partially folded configuration of the preferred embodiment of the present invention viewed from the same perspective as FIG. 1. The single line of sample text printed on panel 10 is exposed.

FIG. 3 is a plan view of the decorative side of the preferred embodiment of the present invention in a partially folded configuration that illustrates one of the multitude of available printed decorative patterns, including printed text and graphics on panels 13 and 16. FIGS. 2 and 3 show opposite sides of the present invention.

FIG. 4 is a plan view of the decorative side of a portion of the preferred embodiment of the present invention after it has been removed along perforations around an aperture in one panel of the preferred embodiment.

FIG. 5 is a plan view of the preferred embodiment of the present invention with a photograph visible in the aperture.

FIG. 6 is a perspective view of the preferred embodiment of the present invention with a photograph visible in the aperture.

### DETAILED DESCRIPTION OF THE PREFERRED EMBODIMENT

“Photograph” in the present Description and Claims means an image of text or graphics or a reproduction of an image of text or graphics produced by human means, a camera, computer, scanner, or by any other means of producing hard copy, in and on any medium.

“Blank” in the present Description and Claims means the product of a stamping, die-cutting, laser-cutting, blade-cutting, or any other process capable of forming a desired shape from a sheet of raw material including but not limited to paper, plastic, fiber, cloth, rubber, foam, wood, or metal.

“Occasion” in the present Description and Claims means a season, holiday, activity, or any event deemed worthy of memorializing or celebrating.

“Mailer” in the present Description and Claims means a device capable of containing articles for transport via a postal system.

The structure and operation of the invention will become apparent upon reading the following detailed description of the preferred embodiment and upon reference to the accompanying drawings. The inventors present herein the best mode for carrying out the present invention in terms of its preferred embodiment (hereafter called “mailer”) that is depicted within the aforementioned drawings.

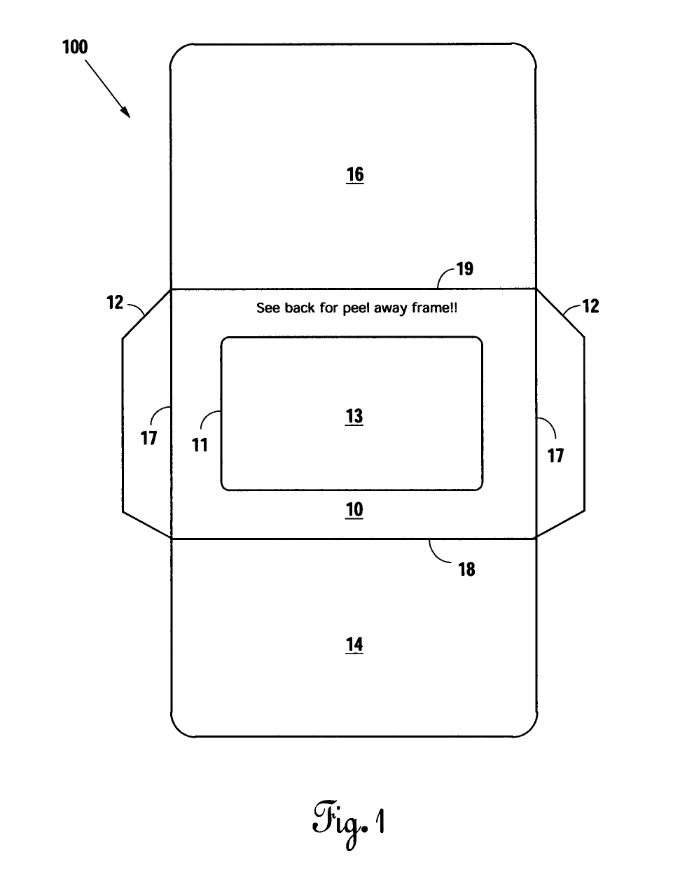

FIG. 1 is an unfolded front view of the non-decorative side of mailer 100 in its blank form, showing a single line of sample text (“See back for peel away frame!!”) printed on the visible side of frame front panel 10. Panel 10 has an aperture panel 13 defined by perforated aperture border 11. Frame front panel 10 also has two wing panels 12 that are foldably connected to frame front panel 10 about fold lines 17. Frame rear panel 14 is foldably connected to frame front panel 10 about fold line 18. Easel panel 16 is foldably connected to frame front panel 10 about fold line 19.

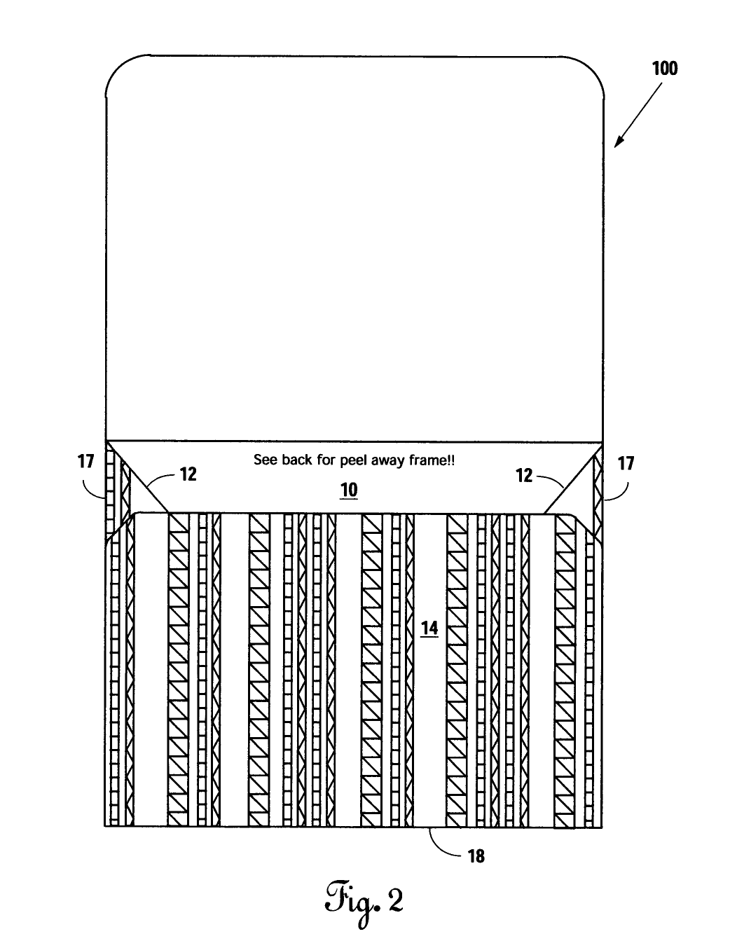

FIG. 2 is a partially folded front view in which some of the decorative side of mailer 100 can be seen. Despite its ornamental appearance, the decorative side of the mailer can perform a useful function. The mailers are decorated with several different graphic designs that have a discernible relationship to the items mailed within. Someone may receive and display hunting and fishing photographs in a mailer decorated with a camouflage motif, baby pictures in a mailer decorated with infant scenes, sports pictures in a mailer decorated with soccer balls, baseballs, and footballs, and birthday photos in a mailer decorated with cakes and candles. The mailer essentially becomes gift wrapping for the items within.

The configuration of FIG. 2 is assembled by folding wing panels 12 about fold lines 17, folding frame rear panel 14 about fold line 18, and applying adhesive between the overlapping areas of wing panels 12 and frame rear panel 14. The pocket thus formed between frame front panel 10 and frame rear panel 14 accommodates photographs and other substantially flat or thin items.

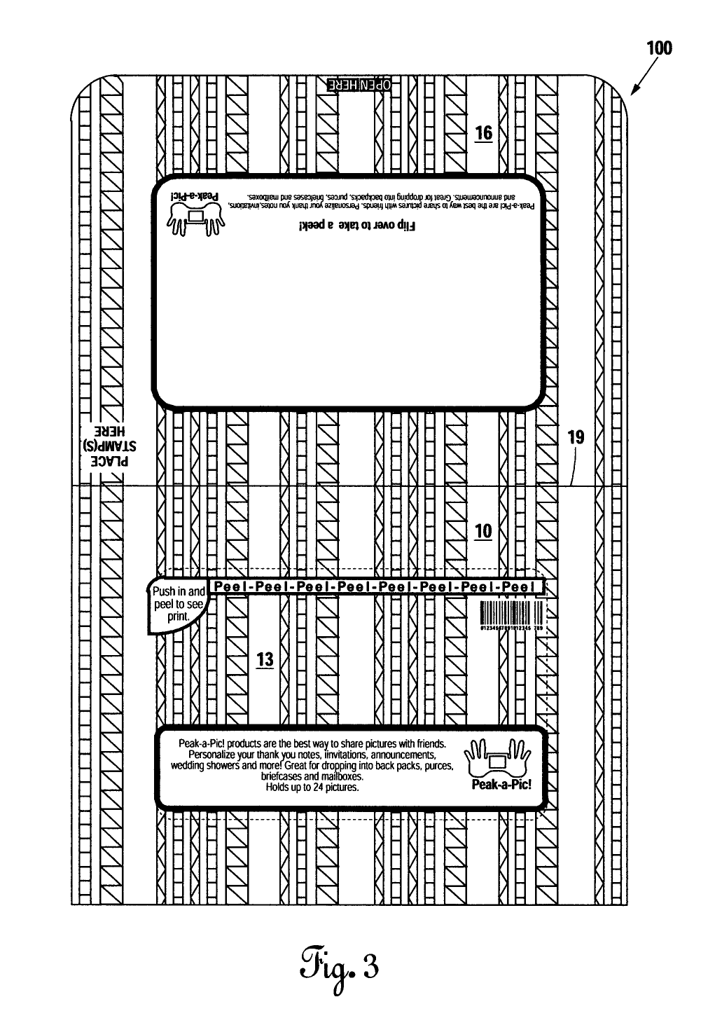

FIG. 3 is a partially folded rear view of mailer 100. The configuration of FIG. 3 is the flip side of the FIG. 2 configuration. Fold line 19 separates front frame panel 10 from easel panel 16. In the illustrated configuration aperture panel 13 exhibits printed information, the product trademark, a bar code, and instructions, as well as decoration. Easel panel 16 exhibits printed information, instructions, the product trademark, an area for postage, and white space for a mailing address, as well as decoration.

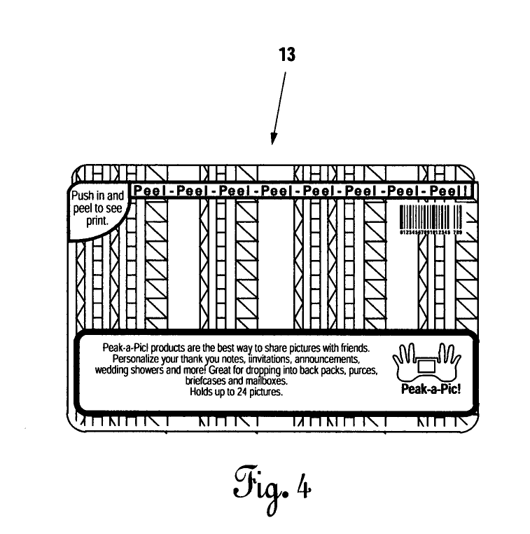

FIG. 4 shows the decorative side of aperture panel 13 after it has been removed along perforations defining aperture border 11 (see FIG. 1) in frame front panel 10. Removing aperture panel 13 reveals the gift within mailer 100.

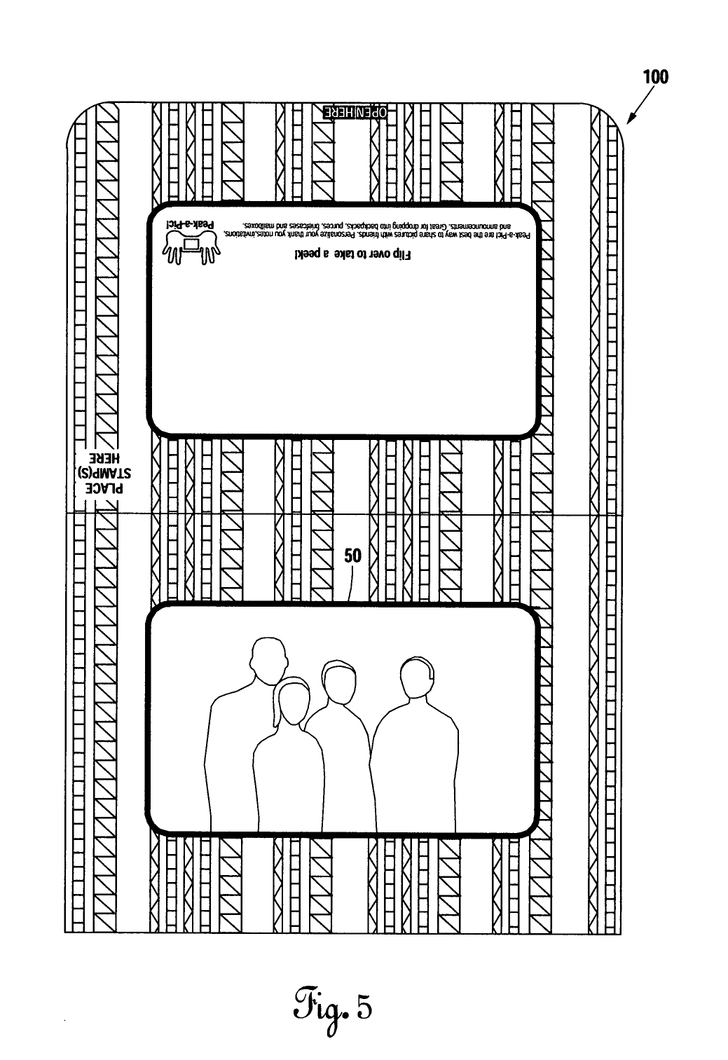

FIG. 5 shows mailer 100 with a photograph 50 inserted into the pocket formed by frame rear panel 14 and frame front panel 10 (see FIG. 2). Photograph 50 is visible through the view port created when aperture panel 13 is removed from frame front panel 10. Photograph 50 could be a single gift, or it could be the top image on a stack of similar gifts.

After the gift or gifts are placed in the pocket formed by frame rear panel 14 and frame front panel 10, the sender may then fold mailer 100 about fold line 19 so that the decorative sides of panels 10, 13, and 16 are exposed. The sender may then seal mailer 100 by applying tape or adhesive along the edge of easel panel 16 in the vicinity of an indicator such as the text “OPEN HERE” illustrated in FIGS. 3 and 5. Alternatively, the sender could seal the mailer with a staple, or, in a different embodiment, with a tab foldably attached to easel panel 16 in the vicinity of the “OPEN HERE” graphics, or on front panel 10.

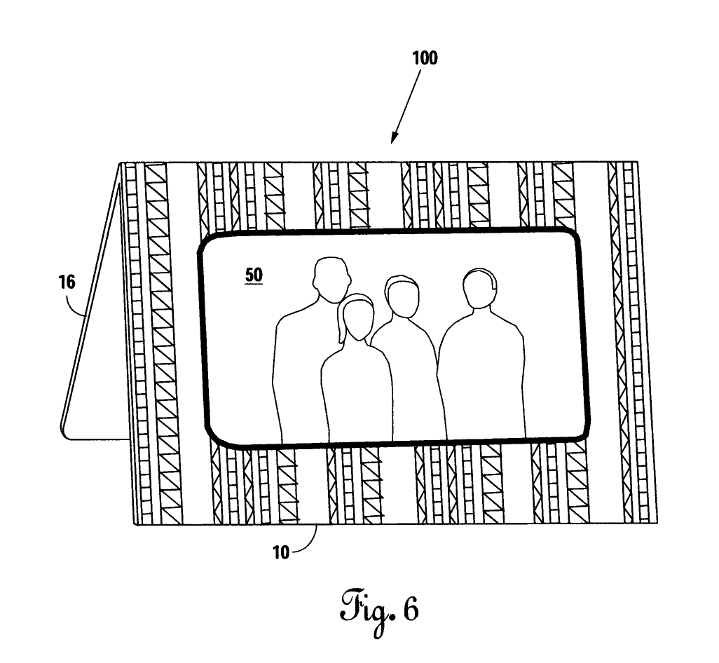

FIG. 6 shows mailer 100 in a display configuration with easel panel 16 folded out rearward from frame front panel 10 along fold line 19 after the recipient opens mailer 100 by breaking whatever seal was applied by the sender. Easel panel 16 supports frame front panel 10 and frame rear panel 14 so that photograph 50 is prominently displayed. The mailer's easel feature permits consumers to send, for the modest expense of an envelope, a means for displaying photographs without the expense of a photo album.

It will be apparent to those with ordinary skill in the relevant art having the benefit of this disclosure that the present invention provides a device for mailing and displaying photographs. It is understood that the form of the invention shown and described in the detailed description and the drawings is to be taken merely as the presently preferred embodiment, and that the invention is limited only by the language of the claim. The drawings and detailed description presented herein are not intended to limit the invention to the particular embodiment disclosed. While the present invention has been described in terms of one preferred embodiment, it will be apparent to those skilled in the art that form and detail modifications can be made to that embodiment without departing from the spirit or scope of the invention.

I claim:

1. A mailer having two sides and comprising:
a frame front panel having an aperture panel made removable by a perforated border;
one or more wing panels foldably connected to said frame front panel;
a frame rear panel foldably connected to said frame front panel;
an easel panel foldably connected to said frame front panel; and
a decorative design printed on at least one side.

2. A mailer as in claim 1, said design including printed instructions for removing said aperture panel.

3. A mailer as in claim 1, said design including space for a mailing address.

4. A mailer as in claim 1, said design including space for postage.

5. A mailer as in claim 1 wherein said design is suggestive of an occasion.

6. A mailer as in claim 1 further comprising:
a means of forming a pocket between said frame front panel and said frame rear panel by folding said wing panels onto said frame front panel, folding said frame rear panel onto said frame front panel, and bonding said frame rear panel to said wing panels; and
a means of removably attaching some part of said easel panel to said frame rear panel.
